(19) United States
(12) Patent Application Publication
(10) Pub. No.: US 2019/0163541 A1
(43) Pub. Date: May 30, 2019

(54) Data Processing System with Energy Transfer

(71) Applicants: CENTRE NATIONAL DE LA RECHERCHE SCIENTIFIQUE, Paris (FR); UNIVERSITE DE MONTPELLIER, Montpellier (FR)

(72) Inventors: Gilles Sassatelli, Montpellier (FR); Abdoulaye Gamatie, Montpellier (FR); Michel Robert, Saint-Clement-De-Riviere (FR)

(73) Assignees: CENTRE NATIONAL DE LA RECHERCHE SCIENTIFIQUE, Paris (FR); UNIVERSITE DE MONTPELLIER, Montpellier (FR)

(21) Appl. No.: 16/092,784

(22) PCT Filed: Apr. 12, 2017
(86) PCT No.: PCT/EP2017/058887

§ 371 Date: Oct. 11, 2018

(30) Foreign Application Priority Data
Apr. 13, 2016 (FR) 1653238

(51) Int. Cl. G06F 9/50; H02J 3/28; G06F 1/26; G06F 1/3212; G06F 1/30; G06F 1/329; G06F 1/3293

(52) U.S. Cl. CPC G06F 9/5094; H02J 3/28; G06F 1/266; G06F 1/3293; G06F 1/305; G06F 1/329; G06F 1/3212

(57) ABSTRACT

The invention relates to a system (200) for distributed computing comprising:
Several nodes (202), each comprising a data processing resource, and
At least two of said nodes (202), called energy nodes (202₁), which are each connected to at least one local electrical energy production device;
   Characterized in that at least one energy node (202₁) is arranged in order to supply another node (202).

The invention also relates to a method operated in said system.

The invention relates to a data processing system, such as high performance computing or the storage or routing of data, with energy transfer.

The field of the invention is the field of information and communication technology and more particularly the field of high performance computing infrastructures (cloud computing), data centres or also server farms.

### STATE OF THE ART

The majority of the systems dedicated to data processing, such as high performance computing or data storage, are arranged in a similar way. They comprise computers, installed in mechanical frames that are organized hierarchically (blades, racks, cabinets) in order to optimize the space occupied, and connected via high-speed local networks. These systems are invariably equipped with devices for heat removal and air conditioning, in order to regulate the ambient temperature. The cost of installation and operation of such systems is high. It is commonly assumed that 30% of the energy costs result from the loss factors in the supply and air conditioning networks. The current consumption is estimated at over 10 MW, i.e. several thousand euros per hour of operation. In addition, the current systems are highly polluting.

Data processing systems are known that use environmentally sound energy sources, such as photovoltaic panels, in addition to a polluting energy source, in order to reduce carbon dioxide emissions. The components of these structures are supplied from the energy sources in a centralized manner. These systems contribute to reducing pollution, but the energy costs associated with the losses in the supply and air conditioning networks remain high. In addition, the installation and maintenance of such systems are costly.

A purpose of the present invention is to overcome these drawbacks.

Another purpose of the invention is to propose a data processing system with a reduced energy consumption.

Another purpose of the invention is to propose a data processing system with a reduced operating cost.

Another purpose of the invention is to propose a data processing system that is less polluting.

### DISCLOSURE OF THE INVENTION

At least one of the aforementioned objectives is achieved by a distributed computing system comprising:
several nodes, each comprising a data processing resource, and
at least two of said nodes, called energy nodes, which are each connected to at least one local electrical energy production device;
   characterized in that at least one energy node is arranged in order to supply another node.

With the system according to the invention, the energy consumed is reduced in comparison with the systems of the state of the art. In fact, routing the energy from an energy node to another node allows a more efficient energy distribution. The routing distance of the energy is reduced. The loss factors in the supply networks are thus considerably reduced, which contributes to reducing the energy consumption of the system.

In addition, at least one node of the system comprises an energy production device, which gives the system a certain level of self-sufficiency. The energy cost of the system is thus reduced.

In addition, the system according to the invention does not need to connect the nodes to a centralized energy source. The installation of the system is thus facilitated and more flexible, and its cost is reduced.

In an embodiment, each node of the system according to the invention can be an energy node. The energy can thus be produced at the level of each node of the system, thus reducing the energy cost. In addition, the energy routing is more easily put in place. The installation and operating costs are thus reduced.

In a preferred version of the system according to the invention, the energy production device can be incorporated into the energy node, in particular so as to form a unit assembly.

According to another embodiment, the energy production device may not be incorporated into the energy node in order to form a unit assembly, and be located at a non-zero distance, for example less than or equal to 10 metres, in particular at 250 cm and even more particularly at 50 cm, from the data processing resources.

For example, the nodes can be arranged on the roof of a building.

Alternatively, for at least one energy node, the energy production device can be situated at a site remote from the site on which the data processing resources are located, for example at a distance greater than 10 metres.

In an advantageous version of the system according to the invention, at least one electrical energy production device can comprise at least one means for harvesting energy from an energy source, for example a renewable resource.

In particular, at least one electrical energy harvesting means can comprise at least one solar panel and/or one wind turbine.

The energy harvesting means can comprise a means for the production of energy from tidal power, or a thermocouple generator, etc.

Preferably, the energy harvesting means is a solar panel.

The dimensions of at least one energy harvesting means can vary depending on the geographical location of the system according to the invention and/or the average energy consumption of at least one node of the system.

For example, in the case of solar panels, provision can be made for the dimensions of at least one solar panel to be such that it can generate at least twice the power of the average energy consumption of at least one node.

According to an embodiment, at least one node of the system according to the invention, in particular an energy node, can comprise at least one electrical energy storage means.

The energy produced locally, or received from another node, can be consumed or stored for subsequent consumption thereof at the level of said node, or routing thereof to at least one other node.

The energy produced locally, or received from another node, can also be consumed.

The storage means can be resistant to high and/or low temperatures and/or can comprise a thermal protection means.

In particular, the self-sufficiency of at least one energy storage means can be comprised between 12 h and 48 h for operation of at least one node at average power.

In addition, the dimensions of at least one energy harvesting means can vary depending on the self-sufficiency and/or the average power of at least one energy storage means.

Such an energy storage means can for example comprise at least one rechargeable battery.

At least one rechargeable battery can be a lithium-ion battery or a lithium-polymer battery, in particular a LiFePO₄ battery.

According to a particular embodiment, the electrical energy production device of at least one energy node can be connected to an electricity distribution network.

The system according to the invention can import, respectively export, electrical energy from, respectively to, the commercial electricity distribution grid and/or export electrical energy to a local electricity network.

Thus, it is possible to harvest, respectively to supply, energy to the system according to the invention when the meteorological conditions are unfavourable, respectively favourable.

The local electricity network can be the electrical network of a structure such as a building, a house, a mobile structure, a mobile home, a container, etc. on/in which the system according to the invention is arranged.

It is also possible to harvest energy from the distribution network when a storage means fails and/or the energy level in a storage means is below a predefined threshold and/or insufficient for supplying a data processing resource and/or for maintaining the energy level in a storage means at a predefined threshold.

In particular, the energy consumption of the system according to the invention can be distributed over at least one energy harvesting means and the electricity distribution network, depending on a required yield of said system.

For example, the yield of the system can produce 80% of the energy consumption through at least one energy harvesting means and 20% of the consumption through the electricity distribution network.

The dimensions of at least one energy harvesting means can vary depending on said required yield.

According to the invention, at least one node of the system can be:
a computing node,
a data storage node, and/or
a data routing node.

A computing node can comprise one or more dedicated processors for computer processing.

A data storage node can comprise one or more mass storage devices.

A data routing node can comprise one or more network, modem or other cards.

The system according to the invention can be used to carry out the following tasks:
high performance computing,
data storage, and/or
transmission/routing of data flows.

Advantageously, at least one node of the system according to the invention can comprise at least one computational grid. The computational grid can comprise at least one multi-core processor, and/or several processors, arranged in series or in parallel. The computational grid can also comprise at least one mass storage device and/or at least one network card.

In particular, at least one node can comprise at least one central processing unit (CPU) and/or at least one graphics processing unit (GPU).

At least one mass storage device can comprise a read-only memory (ROM), a random-access memory (RAM) and/or a flash memory.

The network card can comprise a wired network card, for example copper or optical fibre, and/or a wireless network card, for example provided for a GSM, GPRS, UMTS, LPWAN, LPN and/or WiFi communication, or also a power-line communication (PLC) card.

According to a preferred embodiment, the system according to the invention can comprise a management device configured in order to carry out at least one iteration of the following steps:
selecting one or more nodes for carrying out a task,
when an energy level of at least one selected node is insufficient, transfer of energy to said selected node from at least one other node.

With the system according to the invention, if before or during the execution of a task, the reserve and/or the production of energy of a selected node is/are insufficient, energy can be routed from one or even several other nodes, so that the node in question can carry out the task of calculation, storage or routing of data, which is allocated thereto.

In particular, the management device can be configured in order to carry out the selection of the nodes depending on the available energy levels thereof.

The distribution of the tasks to be carried out is, in this case, subject to the energy availability criterion.

In particular, the tasks can be assigned as a priority to the nodes with a high energy reserve and/or production capacity. In this case the routing of energy is reduced, which limits the losses of load in the distribution networks. Thus, the energy consumption of the system according to the invention can be reduced. The energy consumption of the system according to the invention can be reduced by 10% to 20% with respect to the systems of the state of the art.

Alternatively, the management device can be configured in order to carry out the selection of the nodes depending on the available data processing resources thereof.

In a particular embodiment, the tasks can be assigned as a priority to the nodes with the greatest available data processing resources.

In a particular embodiment, the management device can be configured in order to carry out the selection of the nodes depending on the type of data processing resources, in particular the type of processor (CPU and/or GPU) that said resources comprise.

In addition, at least one node from which electrical energy is transferred can be another selected node, or a node that is not selected, for carrying out a task.

A given task can be distributed over several nodes for its execution. In the event that the energy level of a selected node is insufficient, the energy can be transferred from another selected node or even from a node that is not selected.

Advantageously, the system according to the invention can comprise a device for estimating the available energy over a predetermined duration for at least one energy node.

For an energy node, the device for estimating the available energy can take account of the conditions that influence the production of energy, such as the meteorological conditions, but also the capacity of the energy production means associated with said node, in order to anticipate the amount of energy that may be produced by said energy node.

The device for estimating energy can take account of the storage capacity, the self-sufficiency and/or the number of charging cycles of the energy storage means.

The device for estimating energy can also take account of the energy consumption of the tasks that are currently running and/or awaiting execution.

In particular, the management device can be configured in order to carry out the selection of the nodes depending on:
the availability of the digital resources in the nodes,
the energy consumption of the digital resources in the nodes,
the level of available energy in the nodes,
data returned by the energy estimation device,
the possibility of connecting with the electricity distribution network,
energy losses in the case of energy routing, and/or
the state and ageing statistics of at least one energy storage means.

In an embodiment version, the system according to the invention can comprise at least one node formed by at least one energy production means, which does not comprise data processing resources.

In other words, the system according to the invention can comprise at least one energy production node only. This type of node does not carry out any computing or data storage task or also the transfer of flows for example.

In addition, the different parts of a node such as the digital resources, the energy production device or the energy storage means, operate independently of one another. For example, in the case of deterioration of the data processing resources of a node, its energy production device can be used to produce energy and distribute it to the other nodes.

The system according to the invention can comprise at least one energy transfer means, provided in order to transfer energy from one energy node to another node and/or from one energy harvesting means to a node of the system.

At least one energy transfer means can be an electric cable.

The system according to the invention can comprise at least one data communication means, provided in order to communicate data between:
the nodes of the system,
at least one node and the management device,
at least one energy node and the energy estimation device, and/or
the energy estimation device and the management device.

At least one data communication means can be wired or wireless.

At least one data communication means can use a communication protocol such as the SNMP protocol (Simple Network Management Protocol).

For example, the SNMP protocol (in particular the encapsulation of the SNMP frames) can use IoT (Internet of Things) technology based on the LPWAN/LPN network or use the specific LoRaWan and/or Sigfox communication protocols.

Alternatively, the system according to the invention can comprise at least one energy transfer means, also used in order to communicate data, for example via online carrier currents.

Such a means makes it possible to reduce the space requirement of the system, as it reduces the number of cables necessary.

According to another aspect of the invention a distributed computing method is proposed, with the system according to the invention, comprising at least one iteration of the following steps:
receiving a data processing task,
selecting at least one node to execute said task, and
carrying out said task with the selected nodes;
   characterized in that it comprises a step of energy transfer from at least one energy node to at least one other node.

In particular, the step of selecting the nodes to execute a data processing task can be carried out depending on the available data processing resources thereof.

In this case, the method can also comprise a step of acquisition of the energy level of at least one, in particular of each, selected node. The step of energy transfer can in this case be carried out depending on said energy levels.

Alternatively, the method according to the invention can comprise a step of acquisition of the available energy level of each node, the selection step being capable of being carried out depending on the energy levels.

The energy level, respectively the level of available data processing resources, of each node can be measured/determined at the level of said node, and optionally communicated to the management device:
either on request for example of said management device,
or at a predetermined frequency, or
continuously.

### DESCRIPTION OF THE FIGURES AND EMBODIMENTS

Other advantages and characteristics will become apparent on examination of the detailed description of non-limitative examples and of the attached drawings in which:

FIG. 1 is a diagrammatic representation of a non-limitative embodiment of a node capable of being implemented in the system according to the invention;

FIG. 2 is a diagrammatic representation of a non-limitative embodiment of the system according to the invention;

FIG. 3 is a diagrammatic representation of a first non-limitative embodiment of the method according to the invention; and

FIG. 4 is a diagrammatic representation of a second non-limitative embodiment of the method according to the invention.

It is well understood that the embodiments that will be described hereinafter are in no way limitative. In particular, variants of the invention can be considered comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

In the figures, the elements common to several figures retain the same reference.

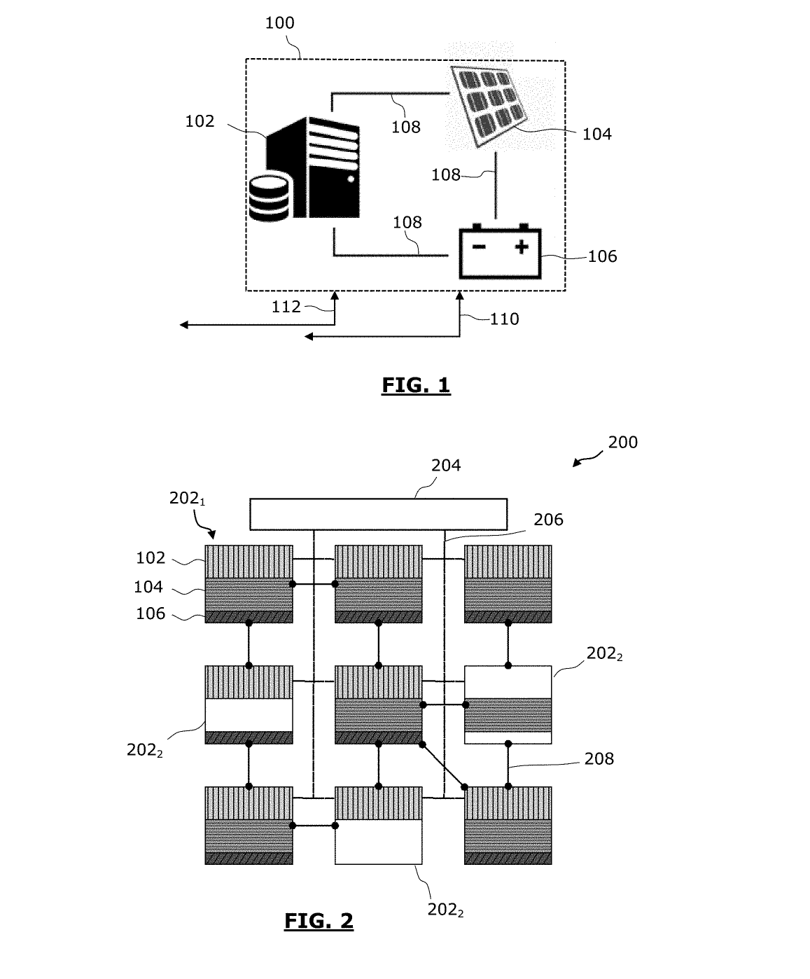

FIG. 1 is a diagrammatic representation of a non-limitative embodiment of a node capable of being implemented in the system according to the invention.

The node 100 comprises a computational grid 102 comprising a multi-core processor, a network card and a mass storage device. The node 100 also comprises a solar panel 104 for harvesting electrical energy from solar radiation. The node 100 also comprises a rechargeable battery 106 for storing the energy produced by the solar panel 104.

The computational grid 102, the solar panel 104 and the battery are connected together by energy transfer cables 108. In addition, the distance separating them is less than or equal to 250 cm, in particular 50 cm.

The node 100 also comprises one or more cables 110 for transmitting and/or receiving electricity to, respectively from, another node and/or the electricity distribution network.

The node also comprises one or more cables 112 for data communication with another node or a management device.

Alternatively, the cable 110 can be used for data communication, for example by online carrier currents.

FIG. 2 is a diagrammatic representation of a non-limitative embodiment of the system according to the invention.

The system 200 represented in FIG. 2 comprises at least two energy nodes 202₁, such as for example the node 100 represented in FIG. 1.

The system 200 also comprises at least one node 202₂ which comprises only a part of the elements of the node 100 in FIG. 1, namely at least a part of the following elements:
a computational grid 102,
a solar panel 104, and
a rechargeable battery 106.

The nodes 202 are arranged in a grid in the system 200. Alternatively, the nodes 202 can be arranged at variable distances depending on the available space.

The system 200 according to the invention also comprises a management device 204. The nodes 202 are connected to the management device 204, and optionally to one another, by communication cables 206. The management device 204 is configured in order to distribute the data processing tasks on the nodes 202 and also in order to supervise the routing of energy between the nodes 202.

The system 200 also comprises several cables 208 for the transfer of energy between the nodes 202. The nodes 202 can be connected to one or more nodes 202 by cables 208.

Alternatively, the system 200 can comprise an individual management device at at least one, in particular each, node 202, instead of a centralized management device 204 for all of the nodes 202.

In addition, the nodes 202 of the system 200 can be arranged so that none, one or several of said nodes 202, but not all the nodes, is/are connected to an electricity distribution network in order to export surplus energy, import supply and/or route energy drawn to other nodes 202.

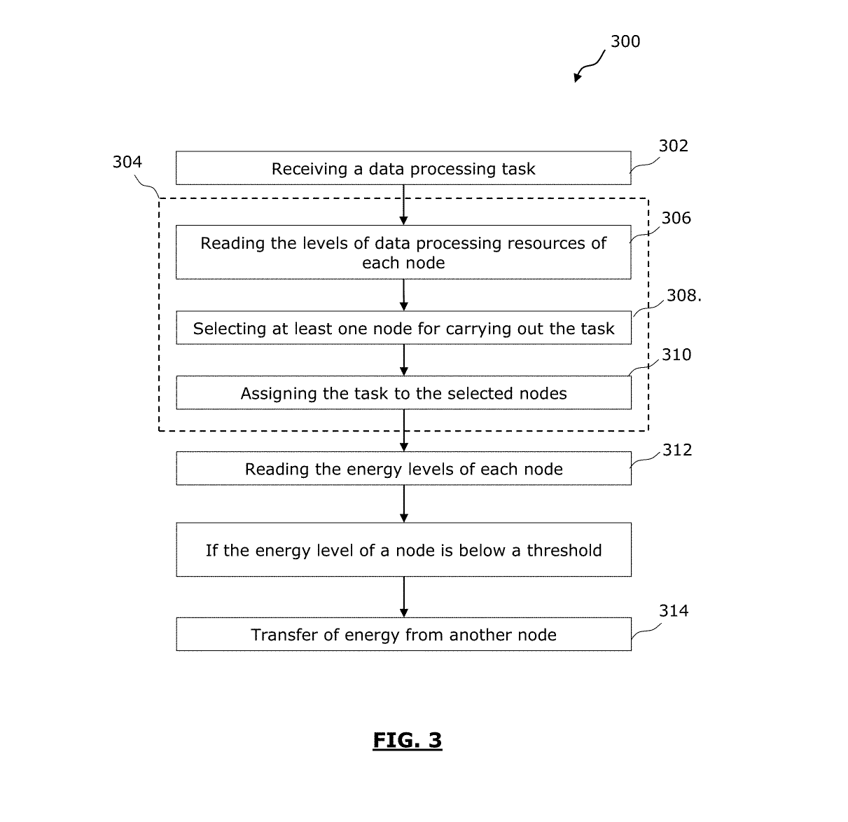

FIG. 3 is a diagrammatic representation of a first non-limitative embodiment of the method according to the invention.

The method 300, represented in FIG. 3, can be implemented for example by the system 200, represented in FIG. 2.

The method 300 comprises a step 302 of receiving a data processing task.

Then, the method 300 comprises a step 304 of selecting nodes to execute the data processing task depending on the level of available data processing resources of each node and the data processing resources necessary for carrying out the task. Step 304 comprises the following steps:
a step 306 of reading the levels of data processing resources for each node, and
a step 308 of selecting at least one node for carrying out the task
a step 310 of assigning the task to said at least one node selected in step 308.

Step 306 can utilize a SNMP communication protocol. The method 300 also comprises a step 312 of reading the energy levels of each node selected in step 308.

When the energy level of at least one selected node is below a threshold, in particular for carrying out the task that was assigned thereto in step 310, a step 314 carries out an energy transfer to this node from another node.

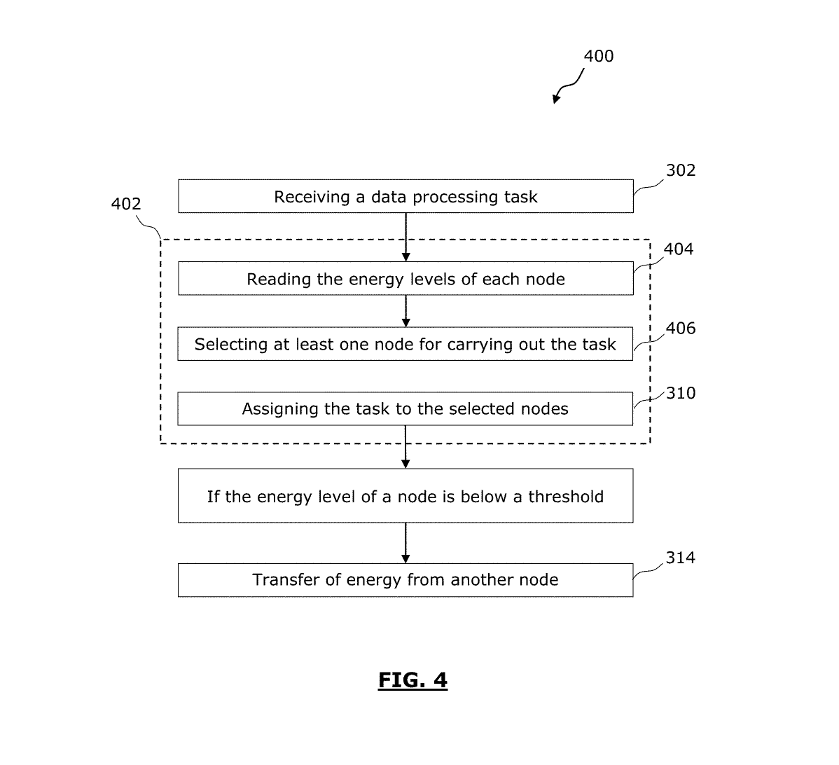

FIG. 4 is a diagrammatic representation of a second non-limitative embodiment of the method according to the invention.

The method 400 can be implemented for example by the system 200 in FIG. 2.

The method 400 comprises step 302 of receiving a data processing task. Then, the method 400 comprises a step 402 of selecting nodes to execute the data processing task depending on the availability of energy in the nodes of the system. Step 402 comprises the following steps:
a step 404 of reading the energy levels of each node, and
a step 406 of selecting at least one node for carrying out the task, and
a step 310 of assigning the task to said at least one node selected in step 408.

When the energy level of at least one selected node is below a threshold, in particular for carrying out the task that was assigned thereto in step 310, step 314 carries out an energy transfer to this node from another node. Said threshold can be defined depending on the energy currently available and that predicted from harvesting.

Of course, the method and the system according to the invention allow planning and/or migration of software objects between the nodes depending on the energy level, and/or the level of data processing resources, and/or the processing type of the processing resources (CPU and/or GPU) of one or more nodes of said system. As such planning and/or such migration are known to a person skilled in the art, it/they will not be detailed further in the present application.

Of course, the invention is not limited to the examples that have just been described and numerous amendments may be made to these examples without departing from the scope of the invention.

What is claimed is:

1. System (200) for distributed computing comprising:
several nodes (100, 202), each comprising a data processing resource, and
at least two of said nodes (100, 202), called energy nodes (100, 2021), which are each connected to at least one local electrical energy production device;
characterized in that at least one energy node (100, 2021) is arranged in order to supply another node (100, 202).

2. System (200) according to claim 1, characterized in that each node (100, 202) of the system is an energy node (100, 2021).

3. System (200) according to claim 1, characterized in that the electrical energy production device comprises at least one means for harvesting energy from an energy source.

4. System (200) according to claim 3, characterized in that the electrical energy harvesting means comprises at least one solar panel (104) and/or a wind turbine.

5. System (200) according claim 1, characterized in that at least one node (100, 202), in particular an energy node (100, 2021), comprises at least one electrical energy storage means.

6. System (200) according to claim 1, characterized in that the electrical energy production device of at least one energy node is connected to the commercial electricity distribution grid.

7. System (200) according to claim 6, characterized in that it imports, respectively exports, electrical energy from, respectively to, the commercial electricity distribution grid and/or exports electrical energy to a local electricity network.

8. System (200) according to claim 1, characterized in that at least one node is:
a calculation node,
a data storage node, and/or
a data routing node.

9. System (200) according to claim 8, characterized in that at least one node (100, 2021, 2023) comprises at least one computational grid (102).

10. System (200) according to claim 1, characterized in that it comprises a management device (206) configured in order to carry out at least one iteration of the following steps:
selecting nodes (100, 202) to execute a task,
when an energy level of at least one selected node (100, 202) is insufficient, transfer of energy to said selected node (100, 202) from at least one other node (100, 202).

11. System (200) according to claim 10, characterized in that the management device (206) is configured in order to carry out the selection of the nodes (100, 202) depending on the available energy levels thereof.

12. System (200) according to claim 10, characterized in that the management device (206) is configured in order to carry out the selection of the nodes (100, 202) depending on the available data processing resources thereof.

13. System (200) according to claim 10, characterized in that the management device (206) is configured in order to carry out the selection of the nodes (100, 202) depending on the type of data processing resources, in particular the type of processor (CPU or GPU) that said resources comprise.

14. System (200) according to claim 10, characterized in that at least one node (100, 202) from which electrical energy is transferred is another selected node (100, 202), or a node (100, 202) that is not selected, for carrying out the task.

15. System (200) according to claim 1, characterized in that it comprises a device for estimating the available energy over a predetermined duration for at least one energy node (100, 2021).

16. System (200) according to claim 1, characterized in that it comprises at least one node (2022) formed by at least one energy production means, and which does not comprise data processing resources.

17. System (200) according to claim 1, characterized in that it comprises at least one energy transfer means, also used in order to communicate data, for example via online carrier currents.

18. Method (300, 400) for distributed computing, with the system according to any one of the preceding claims, comprising at least one iteration of the following steps:
receiving a data processing task,
selecting at least one node (100, 202) to execute said task, and carrying out said task with the selected nodes (100, 202);
characterized in that it comprises a step of energy transfer from at least one energy node (100, 2021) to at least one other node (100, 202).

19. Method (300, 400), according to claim 18, characterized in that the step of selecting the nodes (100, 202) in order to execute a data processing task is carried out depending on the available data processing resources thereof, said method also comprising a step of acquisition of the energy level of at least one, in particular each, selected node (100, 202), the energy transfer step being carried out depending on said energy levels.

20. Method (300, 400) according to claim 18, characterized in that it comprises a step of acquisition of the available energy level of each node (100, 202), the selection step being carried out depending on said energy levels.
